(19) United States
(12) Patent Application Publication
(10) Pub. No.: US 2007/0123639 A1
(43) Pub. Date: May 31, 2007

(54) Hydroxyl group-containing magnetic polymer and method for producing the same

(75) Inventors: Yoshihiro Inaba, Kanagawa (JP); Takako Kobayashi, Kanagawa (JP); Chisato Urano, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co., Ltd.

(21) Appl. No.: 11/446,883

(22) Filed: Jun. 5, 2006

(30) Foreign Application Priority Data
Nov. 28, 2005 (JP) 2005-342609

(51) Int. Cl. C09D 5/02; C08L 33/00

(52) U.S. Cl. 524/556; 524/398

(57) ABSTRACT

According to an aspect of the invention, there is provided a hydroxyl group-containing magnetic polymer which is a particulate hydroxyl group-containing magnetic polymer including a magnetic powder and a polymer of ethylenically unsaturated monomers, the content of the magnetic powder being within the range of from 5 to 90% by mass, the ethylenically unsaturated monomers comprising a hydrophilic monomer having a hydroxyl group and a hydrophobic monomer, and the amount of hydroxyl groups in the portion of the hydroxyl group-containing polymer being within the range of from 0.3 to 5.0 mmol/g.

### CROSS REFERENCE TO RELATED APPLICATION

This application claims priority under 35 USC 119 from Japanese Patent Application No. 2005-342609, the disclosure of which is incorporated by reference herein.

### BACKGROUND

1. Technical Field

The invention relates to a hydroxyl group-containing magnetic polymer and a method for producing the same, and more particularly to a method for producing a hydroxyl group-containing magnetic polymer which is utilized in the form of an aqueous dispersion and which can be used suitably in applications such as image forming materials, magnetic fluids, diagnostic agents, drug carriers, viscosity regulators, resin materials for molding, paint additives, crosslinking/hardening agents and cosmetics additives and intermediate particles for introducing a desired functional group by utilizing hydroxyl groups present in the surfaces of the particles.

2. Related Art

In conventional cases where a polymer is produced by polymerizing a monomer mixture including hydrophilic monomers having a hydroxyl group or the like, since such monomers are water-soluble, a method in which solution polymerization is conducted in an aqueous solution, a method in which emulsion polymerization is conducted in water, a method in which suspension polymerization is conducted in water, and a method in which polymers are produced by reverse phase suspension polymerization are used.

However, when hydrophobic monomers such as styrene are mixed, it is difficult to obtain a copolymer because phase separation occurs.

Further, since the particles resulting from the emulsion polymerization have particle diameters of 1 μm or less, it is difficult to wash such particles for removing impurities such as residual monomers and a surfactant, and therefore, the emulsion polymerization is not suitable in applications in which impurities are undesirable, such as image forming materials, diagnostic agents and drug carriers.

On the other hand, as one of the methods of polymerizing water-soluble ethylenically unsaturated monomers, well-known is so-called “reverse phase suspension polymerization” in which an aqueous solution of monomers is polymerized while being suspended or dispersed in a hydrophobic solvent. However, reverse phase suspension polymerization can be applied mainly to water-soluble monomers, and it is difficult to conduct copolymerization with hydrophobic monomers by reverse phase suspension polymerization.

Meanwhile, it is difficult to conduct copolymerization using a large amount of hydrophobic monomers by reverse phase suspension polymerization.

Further, a method of obtaining a polymer by conducting, in water, suspension polymerization of a monomer mixture containing a water-soluble monomer, a hydrophobic monomer and solvent has a drawback that when suspension polymerization is carried out in water, polymerization occurs also in water, and therefore, particles tend to agglomerate together during the polymerization. Moreover, since water-soluble monomers are distributed into oil droplets and water, it is difficult to produce a polymer with a desired copolymerization ratio.

Moreover, in an attempt to obtain magnetic polymer particles by causing the above-mentioned polymer to contain a magnetic powder, it is difficult to cause the polymer to contain the magnetic powder in a high content due to the difference in specific gravity between the monomer mixture and the magnetic powder. Further, the attempt adversely results in a tendency of particles of the polymer to agglomerate together more easily, which leads not only to decrease in yield but also to poor dispersibility of the magnetic powder within particles. In particular, such problems are remarkable in the case of producing particles having a number average particle diameter of from 0.5 to 5.0 μm.

### SUMMARY

The invention has been made in view of the above circumstances and provides a hydroxyl group-containing magnetic polymer and a method for its production.

According to an aspect of the invention, there is provided a hydroxyl group-containing magnetic polymer which is a particulate hydroxyl group-containing magnetic polymer comprising a magnetic powder and a polymer of ethylenically unsaturated monomers, the content of the magnetic powder being within the range of from 5 to 90% by mass, the ethylenically unsaturated monomers comprising a hydrophilic monomer having a hydroxyl group and a hydrophobic monomer, and the amount of hydroxyl groups in the portion of the hydroxyl group-containing polymer excluding the magnetic powder being within the range of from 0.3 to 5.0 mmol/g.

### DETAILED DESCRIPTION

The invention is described in detail below.

<Hydroxyl Group-Containing Magnetic Polymer>

The hydroxyl group-containing magnetic polymer of the invention is a particulate hydroxyl group-containing magnetic polymer including a magnetic powder and a polymer of ethylenically unsaturated monomers, wherein the content of the magnetic powder is within the range of from 5 to 90% by mass, the ethylenically unsaturated monomers comprise a hydrophilic monomer having a hydroxyl group and a hydrophobic monomer, and the amount of hydroxyl groups in the portion of the hydroxyl group-containing polymer excluding the magnetic powder is within the range of from 0.3 to 5.0 mmol/g.

The hydroxyl group-containing magnetic polymer of the invention is a particulate magnetic polymer which is to be used mainly for aqueous dispersions, such as magnetic printing ink. Therefore, it can be dispersed uniformly in an aqueous medium such as water while holding its magnetism at or over a certain level.

In order to acquire a good dispersibility in an aqueous medium, it is effective to make hydroxyl groups exist in the surface of particles. For this purpose, it is preferred that constituents of the polymer constituting the particles have hydroxyl groups. However, when use of polyester as the polymer is not appropriate because the polymer tends to hydrolyze in water.

For this reason, the invention uses a polymer of ethylenically unsaturated monomers as a polymer. From the viewpoints of dispersibility and stability of polymer particles in an aqueous medium, an examination for determining an optimum range of the amount of hydroxyl groups was made by varying the copolymerization ratio of hydrophilic monomers having a hydroxyl group and hydrophobic monomers included in the polymer. In the invention, there was further found a range where a certain amount of magnetic powder is contained in polymer particles and the amount of hydroxyl group is optimum from the viewpoint of content of the magnetic powder.

The amount of hydroxyl groups in the hydroxyl group-containing magnetic polymer of the invention varies depending on the content of magnetic powder, and therefore, is defined as the amount of hydroxyl groups in the polymer component(s) excluding the magnetic powder. It is necessarily within the range of from 0.3 to 5.0 mmol/g, preferably from 0.4 to 4.0 mmol/g, and more preferably from 0.5 to 3.0 mmol/g.

If the amount of hydroxyl groups is less than 0.3 mmol/g, the dispersibility of the polymer particles in an aqueous medium may be poor. If it is over 5.0 mmol/, the polymer particles have a high swellability in water and, therefore, may be of poor operability.

The amount of hydroxyl groups can be determined by conventional titration method. For example, the amount of hydroxyl groups in a polymer can be determined by adding a prescribed amount of reagent, such as a solution of acetic anhydride in pyridine, to the polymer, heating the mixture, adding water to conduct hydrolysis, separating the mixture into particles and a supernatant using a centrifuge, and titrating the supernatant, for example, with an ethanolic potassium hydroxide solution using an indicator such as phenolphthalein.

The content of the magnetic particles in the hydroxyl group-containing magnetic polymer of the invention is within the range of from 5 to 90% by mass, preferably from 10 to 70% by mass, and more preferably from 20 to 50% by mass.

If the content is less than 5% by mass, it is not possible to obtain a necessary magnetism. If it is over 90% by mass, it is impossible to obtain a uniform dispersibility of the magnetic powder in polymer granules or a dispersion stability of polymer particles.

The hydroxyl group-containing magnetic polymer of the invention, which is in a particulate form, preferably has a number average particle diameter within the range of from 0.5 to 5 μm, and more preferably from 1.0 to 4.0 μm.

If the number average particle diameter is less than 0.5 μm, the particles are too small and may be difficult to be handled. If the number average particle diameter is over 5 μm, use of such a magnetic polymer as an image forming material may fail to provide a high image quality.

The number average particle diameter is a value obtained by photographing dry particles with an optical microscope or an electron microscope, measuring the diameters of 100 to 200 particles chosen randomly from the particles in the photograph, and dividing the sum total of the diameters by the number of the particles measured.

In the invention, it is preferable that the magnetic powder be dispersed uniformly in the polymer particles. In such a case, almost no magnetic powder is present in the surface of polymer particles. It is possible to check the state of a magnetic powder in the surface of particles by electron microscopic observation of the surface. It is preferable that no particles of magnetic powder projecting from the surfaces of all the polymer particles observed are found in the hydroxyl group-containing magnetic polymer of the invention.

The hydroxyl group-containing magnetic polymer of the invention excels in dispersibility in water. The evaluation of the dispersibility in water can be conducted by feeding polymer particles in water of a mass about 20 times the mass of the polymer particles and observing the state of the particles during stirring. In this case, as a container for accommodating the water, an glass container having an opening as wide as about 1 to 10 cm² is used. In this evaluation, it is preferable that all particles of the hydroxyl group-containing magnetic polymer of the invention disperse well in water while no polymer particles float on the surface of the water or sediment on the wall of the container after being stirred.

Particulars of the magnetic powder, ethylenically unsaturated monomers and the like used in the invention will be provided in the description of the method for producing a hydroxyl group-containing magnetic polymer of the invention described later.

The hydroxyl group-containing magnetic polymer of the invention may be produced by any method without particular restrictions. In other words, it may be produced by dry melt kneading pulverization or various types of wet methods. It, however, is preferable, from the viewpoint of yielding uniform polymer particles, to produce the polymer by the method for producing a hydroxyl group-containing magnetic polymer of the invention described below.

<Method for Production of Hydroxyl Group-Containing Magnetic Polymer>

The method for producing a hydroxyl group-containing magnetic polymer of the invention comprises ;dispersing a mixture prepared by mixing ethylenically unsaturated monomers including a hydrophilic monomer having a hydroxyl group and a hydrophobic monomer, an organic solvent, a polymerization initiator and a magnetic powder the surface of which has been subjected to hydrophobicizing treatment, in an aqueous medium in which a salt has been dissolved and to which a dispersion stabilizer has been added, followed by conducting suspension polymerization.

As mentioned above, when a hydrophobic monomer and a hydrophilic monomer having a hydroxyl group are mixed and the mixture is subjected to suspension polymerization in water, particles tend to agglomerate together and there was a problem that it is difficult to form a polymer with a desired copolymerization ratio. This is because since the hydrophilic monomers are water-soluble, some hydrophilic monomers diffuse from oil droplets, which disperse as a monomer mixture in water, to water and polymerization occurs also in water other than the oil droplets.

Moreover, when a polymer contains a hydrophobic component, a magnetic powder is hardly contained in the polymer because the surface of the magnetic powder is relatively hydrophilic. In addition, phase separation between hydrophobic monomer components and hydrophilic monomer components in a polymer tends to render the dispersibility of a magnetic powder less uniform.

The inventors tried to solve these problems from the following three standpoints, namely, (1) causing a monomer mixture to exist as suspension particles which are uniform and stable in an aqueous medium, (2) improving the dispersibility of a magnetic powder in a monomer mixture, and (3) inhibiting the particles from agglomerating during polymerization.

First, regarding item (1), addition of an organic solvent to a mixture of a hydrophilic monomer, a hydrophobic monomer and a magnetic powder improves the compatibility between the hydrophilic monomer and the hydrophobic monomer, which differ in polarity, and, therefore, makes it possible to form suspension particles stable in an aqueous medium. There, however, is a problem that the inclusion of the magnetic powder increases the viscosity of the monomer mixture and, therefore, it becomes difficult to allow the monomer mixture to exist as fine suspension particles in an aqueous medium. In particular, when the amount of the magnetic powder is over 45% by mass, this problem is remarkable. It has been found that addition of an organic solvent into a mixture of a hydrophobic monomer and a magnetic powder leads to decrease in viscosity of the liquid and makes it possible to form suspension particles stable in an aqueous medium.

Next, it became possible to deal with item (2) by subjecting the surface of a magnetic powder to hydrophobicizing treatment. Since the surface of a magnetic powder is basically hydrophilic, hydrophobicizing treatment of the surface can enhance the affinity of the surface to a hydrophobic monomer. The dispersion uniformity of a magnetic powder in particles and the content of the magnetic powder in the particles have been increased as a result of a synergistic effect of the enhancement of the affinity and the increase in compatibility of a hydrophilic monomer and a hydrophobic monomer.

Moreover, also in the above-mentioned case, the salt is dissolved in the aqueous medium in order to prevent a hydrophilic monomer, which may contain a magnetic powder, from diffusing from suspension particles into an aqueous medium, and the monomer mixture including the hydrophilic monomer is successfully arranged preferentially in the oil layer of the suspension polymerization system by virtue of the salting out effect.

On the other hand, regarding item (3), it may be said that because the dissolution of a salt in the aqueous medium inhibit generation of emulsion polymerization occurring during the suspension polymerization, it has an effect also on agglomeration of particles. Moreover, it has been found that addition of a dispersion stabilizer into an aqueous medium can inhibit agglomerated particles from further agglomerate together.

That is, in the invention, the operations (1) to (3) are demonstrated and it becomes possible to effect a stable polymerization reaction in suspended particles including a hydrophilic monomer, a hydrophobic monomer and a magnetic powder uniformly only after satisfaction of the four conditions, namely, addition of an organic solvent to a mixture including monomers and a magnetic powder, hydrophobicizing treatment to the surface of the magnetic powder, dissolution of a salt in an aqueous medium, and addition of a dispersion stabilizer.

This realized producing, simply and at a favorable yield, a hydroxyl group-containing magnetic polymer including a copolymer of a hydrophobic monomer and a hydrophilic monomer and a magnetic powder dispersed in the copolymer in a desired content, in such a production it having heretofore been difficult to control the copolymerization ratio.

The method for producing a hydroxyl group-containing magnetic polymer of the invention is described in detail below. It is noted that the term “ethylenically unsaturated monomer” as used herein refers to a monomer which has an ethylenically unsaturated group such as a vinyl group. Both the following hydrophilic monomer and hydrophobic monomer are encompassed by the ethylenically unsaturated monomer in the invention.

(Mixing Monomers)

—Hydrophilic Monomer Having a Hydroxyl Group—

Examples of the hydrophilic monomer having a hydroxyl group to be used in the invention include 2-hydroxylethyl(meth)acrylate, 2-hydroxypropyl(meth)acrylate, 3-hydroxypropyl(meth)acrylate, glycerin(meth)acrylate, 1,6-bis(3-acryloxy-2-hydroxypropyl)-hexyl ether, pentaerythritol tri(meth)acrylate, tris-(2-hydroxyethyl)isocyanurate(meth)acrylate and polyethylene glycol(meth)acrylate.

The term “(meth)acrylate” as used herein expresses acrylate or methacrylate.

It is preferable, from the viewpoints, for example, of control of copolymerization ratio with a hydrophobic monomer mentioned later and controllability of polymerization reaction, to use at least one selected from 2-hydroxyethyl(meth)acrylate and polyethylene glycol(meth)acrylate.

—Hydrophobic Monomer—

Examples of the hydrophobic ethylenically unsaturated monomer include aromatic vinyl monomers such as styrene and α-methylstyrene; alkyl(meth)acrylates having an alkyl or aralkyl group having from 1 to 18, preferably from 2 to 16, carbon atoms (e.g., methyl (meth)acrylate, ethyl(meth)acrylate, propyl(meth)acrylate, butyl(meth)acrylate, cyclohexyl(meth)acrylate, 2-ethylhexyl(meth)acrylate, lauryl(meth)acrylate and benzyl (meth)acrylate); alkoxyalkyl(meth)acrylates having an alkylene group having from 1 to 12, preferably from 2 to 10, carbon atoms (e.g., methoxymethyl(meth)acrylate, methoxyethyl (meth)acrylate, ethoxymethyl(meth)acrylate, ethoxyethyl(meth)acrylate, ethoxybutyl (meth)acrylate, n-butoxymethyl(meth)acrylate and n-butoxyethyl(meth)acrylate); amino group-containing(meth)acrylic acid esters (e.g., diethylaminoethyl(meth)acrylate and dipropylaminoethyl(meth)acrylate); acrylonitrile, ethylene, vinyl chloride and vinyl acetate.

Among these, styrene, methyl(meth)acrylate, butyl(meth)acrylate, 2-ethylhexyl (meth)acrylate, lauryl(meth)acrylate, ethoxybutyl(meth)acrylate, benzyl(meth)acrylate and diethylaminoethyl(meth)acrylate are preferred. Styrene, methyl(meth)acrylate, and butyl(meth)acrylate are particularly preferred.

The content of the hydrophobic monomer copolymerizable with the hydrophilic monomer is preferably within the range of from 20.0 to 99.9% by mass, and more preferably from 50.0 to 90.0% by mass of the total monomer components.

If the content is less than 20.0% by mass, the amount of hydroxyl groups in the polymer becomes too large and it may become impossible to achieve a uniform polymerization even by the method of the invention. If the content is over 99.9% by mass, a resulting polymer may not enjoy the effect of hydrophilicity caused by hydroxyl groups.

—Other Monomers—

A crosslinking agent may, if necessary, be mixed with a reactive mixture (including the ethylenically unsaturated monomers and the like) to be dispersed in an aqueous medium, which is described later. Addition of a crosslinking agent to a mixed solution of monomers makes it possible to form granular hydroxyl group-containing magnetic polymer particles.

As the crosslinking agent to be used, conventionally known crosslinking agents may properly be selected and used, and preferable examples are divinylbenzene, ethylene glycol di(meth)acrylate, diethylene glycol di(meth)acrylate, methylene bis(meth)acrylamide, glycidyl(meth)acrylate, and 2-([1′-methylpropylidenamino]carboxyamino) ehyl methacrlate. Among them, divinylbenzene, ethylene glycol di(meth)acrylate, diethylene glycol di(meth)acrylate are more preferable, and divinylbenzene is even more preferable.

The addition amount of the crosslinking agent is preferably 0.1 to 100 parts by mass and more preferably 0.5 to 50 parts by mass based on 100 parts by mass of the total monomer components.

Examples of other ethylenically unsaturated monomers include acrylamides and glycidyl(meth)acrylate. These may be used if necessary in addition to the hydrophilic monomers and hydrophobic monomers.

—Magnetic Powder—

As a magnetic powder, magnetites or ferrites expressed by a formula MO.Fe₂O₃ or M.Fe₂O₄, which exhibit magnetism, are preferably used. Here, M is a divalent or univalent metal ion (Mn, Fe, Ni, Co, Cu, Mg, Zn, Cd, Li, etc.). Either one kind of metal or two or more kinds of metals may be used as M. Examples are iron oxides such as magnetite, γ iron oxide, Mn—Zn ferrite, Ni—Zn ferrite, Mn—Mg ferrite, Li ferrite and Cu—Zn ferrite. In particular, magnetite, which is inexpensive, can be used more preferably.

Furthermore, it is possible to employ non-magnetic metal oxides such as those using one or more metals selected from Mg, Al, Si, Ca, Sc, Ti, V, Cr, Mn, Fe, Co, Ni, Cu, Zn, Sr, Y. Zr, Nb, Mo, Cd, Sn, Ba, Pb, etc., and the aforementioned magnetic metal oxides. For example, Al₂O₃, Sio₂, CaO, TiO₂, V₂O₅, CrO₂, MnO₂, Fe₂O₃, CoO, NiO, CuO, ZnO, SrO, Y₂O₃, ZrO₂, etc. may be used as a non-magnetic metal oxide,

Magnetic powders before hydrophobicizing treatment mentioned below preferably have an average primary particle diameter within the range of from 0.02 to 2.0 μm. If the average primary particle diameter of a magnetic powder is outside the range, the magnetic powder easily agglomerates and it may be difficult to disperse the powder uniformly in polymerizable monomers.

In the invention, magnetic powders must be hydrophobicized on their surfaces. The method of the hydrophobicizing treatment is not particularly restricted and it may be achieved, for example, by covering the surface of a magnetic powder with a hydrophobicizing agent such as various types of coupling agents, silicone oils and resins. In particular, surface covering treatment using a coupling agent is preferred.

Examples of such a coupling agent include silane coupling agents and titanium coupling agents. More preferably used are silane coupling agents. Silane compounds of a structure represented by the following formula (1) are particularly preferred:
RmSiYn Formula (1)
wherein R is an alkoxyl group, m is an integer of from 1 to 3, Y represents a hydrocarbon group like alkyl groups, a vinyl group, a glycidoxy group and a methacryl group, and n is an integer of from 1 to 3.

Specific example thereof include vinyltrimetoxysilane, vinyltriethoxysilane, γ-methacryloxypropyltrimethoxysilane, vinyltriacetoxysilane, methyltrimethoxysilane, methyltriethoxysilane, isobutyltrimethoxysilane,. dimethyldimethoxysilane, dimethyldiethoxysilane, trimethylmethoxysilane, hydroxypropyltrimethoxysilane, phenyltrimethoxysilane, phenethyltrimethoxysilane, n-hexadecyltrimethoxysilane and n-octadecyltrimethoxysilane.

In particular, it is preferable to hydrophobicizing a magnetic powder by use of alkyltrialkoxysilane coupling agents represented by CₚH₂ₚ₊₁—Si—(OC_{q}H_{2q+1})₃ wherein p is an integer of from 2 to 20 and q is an integer of from 1 to 3, or aralkyltrialkoxysilane coupling agents represented by C₆H₅—CᵣH₂ᵣ—Si—(OCₛH₂ₛ₊₁)₃ wherein r is an integer of from 2 to 20 and s is an integer of from 1 to 3. The term “aralkyl” as used herein means a hydrocarbon group which has both an aromatic structure and an aliphatic structure. That is, an alkyl hydrogen atom has been substituted by a substituted or unsubstituted aryl group. Examples of such an aralkyl group include a benzyl group, a phenethyl group and an α-mesityl group.

In the formulas, if p and r are smaller than 2, it is easy to apply hydrophobicizing treatment, but it is difficult to impart hydrophobicity to a satisfactory extent and it may be difficult to inhibit a magnetic powder from exposing on polymer particles. If p and r are greater than 20, a satisfactory hydrophobicity is achieved, but much agglomeration of magnetic particles occurs and it may be difficult to disperse a magnetic powder in a polymer to a satisfactory extent.

Further, if q and s are greater than 3, the reactivities of the silane coupling agents are low and it is difficult to achieve hydrophobicization to a satisfactory extent.

Among those mentioned above, the alkyltrialkoxysilane coupling agents represented by CₚH₂ₚ₊₁—Si—(OC_{q}H_{2q+1})₃ are particularly preferably used in achieving a favorable dispersibility in polymerizable monomers.

The hydrophobicizing treatment of a magnetic powder, for example in the case of silane coupling agent treatment, may be conducted in conventional ways such as dry treatment in which a vaporized silane coupling agent is caused to react with a magnetic powder which has been transformed into a cloud-like form by stirring; wet treatment in which a magnetic powder is dispersed in a solvent and a silane coupling agent is dropped thereto to cause a reaction; or treatment in which a magnetic powder is dispersed in a solvent and then a silane coupling agent is added, followed by evaporation of the solvent by use of a distillation apparatus such as a rotary evaporator, thereby heat-treating the magnetic powder on which the silane coupling agent has been attached. The hydrophobicizing treatments may be suitably combined together.

The amount of the hydrophobicizing agent with which the magnetic powder is treated in the hydrophobicizing treatment in the invention is preferably within the range of from 0.05 to 20 parts by mass, and more preferably from 0.1 to 10 parts by mass based on 100 parts by mass of the magnetic powder.

The magnetic powder hydrophobicized is mixed to a mixture of the aforementioned polymerizable monomer, etc. as described later. In the invention, the content of the magnetic powder, which may be determined depending on a magnetism required, is preferably within the range of from 5 to 90% by mass, and more preferably from 10 to 50% by mass based on the total amount of the constituents of the polymer particles. If the content is less than 5% by mass, it may be impossible to achieve a satisfactory magnetism, whereas if it is more than 90% by mass, the operability may be poor due to too fast sedimentation of polymer particles in an aqueous medium when the polymer particles are dispersed in the aqueous medium.

—Organic Solvent—

As the organic solvent to be used in the invention, any organic solvent may be used in principle if it is poorly soluble in water, it has a boiling point higher than the reaction temperature of the polymerization and it does not inhibit the polymerization. Examples of such solvent include, but are not restricted to, hydrocarbons, alcohols, ketones and ethers.

The hydrocarbons may be aliphatic hydrocarbons and aromatic hydrocarbons. Examples of the aliphatic hydrocarbon include hexane, heptane, octane, dodecane, cyclohexane, decahydronaphthalene, petroleum type hydrocarbons and naphthene type hydrocarbons. Examples of the aromatic hydrocarbon include toluene, xylene, diethylbenzene and dodecylbenzene.

As the alcohol, aliphatic alcohols having from 8 to 24 (preferably from 12 to 22) carbon atoms may be used. Both acyclic aliphatic alcohols and alicyclic alcohols may be used. Moreover, both naturally occurring alcohols and synthetic alcohols (e.g., Ziegler alcohol and oxo alcohols) may be used. Alkyl group moieties may be in a straight chain form or a branched form.

As an acyclic aliphatic alcohol, saturated aliphatic alcohols and unsaturated alcohols may be used. Examples of such noncyclic saturated aliphatic alcohols include isoamyl alcohol, octyl alcohol, nonyl alcohol, decyl alcohol, undecyl alcohol, dodecyl alcohol (lauryl alcohol), tridecyl alcohol, tetradecyl alcohol, hexadecyl alcohol, octadecyl alcohol, nonadecyl alcohol and tetracosenyl alcohol. Examples of acyclic unsaturated aliphatic alcohols include octenyl alcohol, decenyl alcohol, dodecenyl alcohol, tridecenyl alcohol, pentadecenyl alcohol, oleyl alcohol, tetracosenyl alcohol, gadoleyl alcohol and linoleyl alcohol.

As an alicyclic alcohol, monocyclic aliphatic alcohols and polycyclic aliphatic alcohols may be used. Examples of such monocyclic aliphatic alcohols include ethylcyclohexyl alcohol, a propylcyclohexyl alcohol, octylcyclohexyl alcohol, nonylcyclohexyl alcohol and stearylcyclohexyl alcohol. Examples of polycyclic aliphatic alcohols include adamantyl alcohol and dicyclohexyl alcohol.

As the ketones, aliphatic or aromatic ketones having from 6 to 22 (preferably from 7 to 12) carbon atoms may be used. Regarding aliphatic ketones, both acyclic aliphatic ketones and alicyclic ketones may be used. Alkyl group moieties may be in a straight chain form or a branched form. Examples of such ketones include dipropyl ketone, methyl amyl ketone, methyl hexyl ketone and diisobutyl ketone.

As the ethers, aliphatic or aromatic ethers having from 6 to 22 (preferably from 7 to 12) carbon atoms may be used. Regarding aliphatic ethers, both acyclic aliphatic ethers and alicyclic ethers may be used. Alkyl group moieties may be in a straight chain form or a branched form. Examples of such ethers include ethylene glycol dibutyl ether, methyl phenyl ether, butyl phenyl ether and diethylene glycol dibutyl ether.

Such solvents may be used singly or in combination.

For the reasons mentioned above, the organic solvent to be used in the invention preferably has an affinity to both the hydrophilic monomers and the hydrophobic monomers. Regarding the choice of a specific organic solvent, it is preferable to choose a solvent which has the following properties: having a boiling point higher than that of the ethylenically unsaturated monomer to be used, being poorly soluble in water, not inhibiting the polymerization, and being highly compatible. The choice of an organic solvent in combination with monomers may vary the yield of a polymer finally formed. The solvent may be either one which dissolves both monomers and their polymer or one which dissolves monomers but does not dissolve their polymer.

From such a standpoint, it is preferable to use, as an organic solvent, at least one selected from diethylbenzene, lauryl alcohol and isoamyl alcohol.

Further, it is desirable to adjust the solubility (i.e., solubility parameter) and surface tension of the organic solvent with the ethylenically unsaturated monomer to be used. As a measure for this, use of two or more kinds of solvents in combination is also preferable.

The content of the organic solvent in the monomer mixture in the invention is preferably within the range of from 5 to 80% by mass, and more preferably from 10 to 60% by mass.

—Polymerization Initiator—

Preferable examples of the polymerization initiator to be used in the invention include azo type polymerization initiators and peroxide type polymerization initiators. Particularly, initiators soluble in oil are preferred.

Examples of azo type initiators soluble in oil include azobisisobutyronitrile (AIBN), 2,2′-azobis(2-methylbutyronitrile), 2,2′-azobis(2,4-dimethylvaleronitrile), dimethyl 2,2′-azobis(2-methylpropionate) and 1,1′-azobiscyclohexane-1-carbonitrile. Examples of peroxide type initiators soluble in oil include benzoyl peroxide, acetyl peroxide, decanoyl peroxide, lauroyl peroxide, o-methoxybenzoyl peroxide, p-chlorobenzoyl peroxide, 2, 4-dichlorobenzoyl peroxide, diisopropyl percarbonate, di-2-ethylhexyl peroxidicarbonate, acetylcyclohexylsulfonyl peroxide, tert-butyl perisobutyrate, tert-butyl perpivalate, tert-butyl 2-perethylhexanoate, tert-butyl peroxide, tert-butylcumyl peroxide, dicumyl peroxide, methyl ethyl ketone peroxide, cumene hydroperoxide and tert-butyl hydroperoxide.

Such polymerization initiators may be used in any amount, but the amount thereof is preferably within the range of from 0.05 to 10 parts by mass, and more preferably from 0.1 to 5 parts by mass based on 100 parts by mass of the total monomer components.

(Other Additives)

The hydroxyl group-containing magnetic polymer of the invention is allowed to further contain dyes, pigments, carbon black, etc. for the purpose of coloring the polymer. In such a case, the additives may be incorporated into a mixture of the monomers.

The mixture including the monomers, etc. is prepared by mixing the ethylenically unsaturated monomers, an organic solvent, a polymerization initiator, a magnetic powder and other necessary components. The method of the mixing is not particularly restricted, but it is preferable to add an organic solvent to ethylenically unsaturated monomers including hydrophilic monomers and hydrophobic monomers, followed by stirring the mixture for about 5 minutes so as to enhance the compatibility between the both types of monomers and subsequently adding a magnetic powder.

(Suspending a Mixture in an Aqueous Medium)

—Aqueous Medium—

As the aqueous medium in the invention, water or a medium prepared by adding a water-soluble organic solvent, such as methanol and ethanol, to water is preferably used. Use of only water is particularly preferred. In the case of adding a water-soluble organic solvent, the addition amount thereof, which depends on the properties of the monomers to be suspended, is preferably 30% by mass or less, more preferably 10% by mass or less of the entire solvent. When the addition amount is adjusted to 30% by mass or less, it may be possible to maintain a favorable dispersion stability.

—Salt—

One essential feature of the invention is that a salt is dissolved in the aqueous medium. The reaction of emulsion polymerization is inhibited by a salting out effect, dispersion stability of suspension particle is obtained and, as a result, a good yield can be realized.

Although the salt to be dissolved may be either water-soluble inorganic salts or water-soluble organic salts, inorganic salts are particularly preferable because they can exert the salting out effect effectively. Example of such inorganic salts include sodium chloride, potassium chloride, potassium carbonate, calcium chloride, ammonium chloride, sodium sulfate, sodium acetate, ammonium sulfate, magnesium chloride and magnesium sulfate. Among these, sodium chloride, potassium chloride, potassium carbonate, and calcium chloride are more preferred, and sodium chloride is particularly preferred.

Regarding the amount of the salt to be added, from the viewpoint of dispersion stability, it is preferable to dissolve the salt in the aqueous medium in an amount of 5% by mass or more, more preferably 10% by mass or more, and even more preferably 15% by mass or more.

If the amount of the salt dissolved is less than 5% by mass, a sufficient salting out effect is not acquired and emulsion polymerization may tend to occur.

—Dispersion Stabilizer—

In the invention, one of the essential features is to cause a dispersion stabilizer to exist in the aqueous medium. As such dispersion stabilizers, known ones may be used, but use of an inorganic powder, such as calcium carbonate and calcium phosphate, is preferable because it is effective for improving the dispersibility of suspension particles in the invention and it can inhibit the agglomeration of the particles. It is preferable, from the standpoint of enhancing the stability of dispersion particles, that the surface of the inorganic powder is coated with a surface modifier. It is also preferable to use a surfactant, such as anionic emulsifiers, nonionic emulsifiers and cationic emulsifiers, in addition to the inorganic powders.

The dispersion stabilizer may be used in an optional amount, but preferably is used in an amount within the range of from 1 to 100 parts by mass, and more preferably from 2 to 90 parts by mass based on 100 parts by mass of the mixture including the monomers and the magnetic powder. Use of the dispersion stabilizer in an amount of 1 part by mass or more can form a favorable dispersion state, whereas use of the agent in an amount of 100 parts by mass or less advantageously inhibit generation of fine particles to sharpen the particle size distribution of suspension particles.

To the aqueous medium in the invention, a viscosity enhancer may also be added in order to regulate the particle size of suspension particles. Polycarboxylic acid salts, such as sodium carboxymethylcellulose, sodium alginate and sodium polyacrylate, may be added as the viscosity enhancer.

When such viscosity enhancer is used, it is preferable for the viscosity of the aqueous medium to be adjusted within the range of from 100 to 10000 mPa·s.

The suspension of a mixture including the aforementioned monomers into an aqueous medium including the aforementioned salt, etc. (hereinafter occasionally referred to as a dispersion medium) may be conducted by the following way.

That is, to an aqueous medium in which the aforementioned salt has been dissolved and a dispersion stabilizer exists, a mixture including hydrophilic monomers, hydrophobic monomers, a magnetic powder, a polymerization initiator, a cross linking agent, etc. is added and suspended. For the suspension, known suspension methods may be used. Examples of such methods include mechanical suspension methods such as a method in which monomers and the like are suspended in an aqueous medium by rotating a special stirring blade, such as a mixer, at a high speed, a method in which suspension is conducted utilizing a shear force generated by a rotor and stator, which is known as a homogenizer, and a method in which suspension is conducted utilizing ultrasonic waves.

Besides, the suspension may also be conducted using an emulsification method, which is known as membrane emulsification, in which a liquid including the aforementioned monomers and the like is prepared and then extruded into an aqueous medium through a porous membrane.

The mixing mass ratio of the mixture to be suspended and the dispersion medium (mixture/dispersion medium) is preferably within the range of from 10/100 to 100/100. The number average particle diameter of the particles suspended is preferably within the range of from 0.5 to 10 μm.

(Polymerizing Suspension Particles)

In the invention, a polymer is obtained by subjecting the aforesaid particles including the suspended monomers and a magnetic powder to suspension polymerization. The polymerization reaction can be conducted not only under the atmospheric pressure but also under an increased pressure. Such conditions may be applied depending on necessities and are not particularly restricted.

Regarding reaction conditions, it is preferable, from the standpoint, for example, of obtaining a polymer at a high yield, to cause a suspension including the suspension particles dispersed therein to react at a reaction temperature of from 40 to 100° C. for 1 to 24 hours while stirring the suspension under the atmospheric pressure, for example.

The thus-obtained polymer may be isolated as a powder by removing the dispersion stabilizer, diluting and dispersing the polymer in a solvent such as methanol, filtering, washing it with water and/or detergent, and drying it by normal methods such as spray drying, reduced pressure drying and freeze drying.

<Properties of Hydroxyl Group-Containing Magnetic Polymer>

(Amount of Hydroxyl Groups and Number Average Particle Diameter)

The amount of hydroxyl groups in the resulting hydroxyl group-containing magnetic polymer and the number average particle diameter of the polymer can be determined by the same methods as those previously described. A preferable amount of hydroxyl groups and a preferable number average particle diameter of a polymer produced by the method for producing a hydroxyl group-containing magnetic polymer of the invention are the same as those described previously for the hydroxyl group-containing magnetic polymer of the invention.

In the measurement of a number average particle diameter, it is preferable that no agglomerated particles (namely, particles composed of a plurality of particles aggregating or deformed particles each composed of one core particle and fine particles attaching to the core particle) are found at all.

(Molecular Weight)

The molecular weight (number average molecular weight) of the hydroxyl group-containing polymer of the invention may vary depending on its application. When no crosslinking agent is added during the polymerization, it is preferably within the range of from 5000 to 1000000, and more preferably from 10000 to 500000.

The number average molecular weight was measured using the gel permeation chromatography (GPC). The measurement is carried out using an HLC-8120GPC, SC-8020 (manufactured by Tosoh Corporation) as a GPC, two columns TSKgel SuperHM-H (manufactured by Tosoh Corporation, 6.0 mmID×15 cm), and THF (tetrahydrofuran) as an eluant.

(Dispersibility of Magnetic Powder, and Dispersibiliy in Water)

In the hydroxyl group-containing magnetic polymer of the invention, a magnetic powder is dispersed uniformly inside particles and therefore almost no magnetic powder is present on the surfaces of the particles. Since the particles have hydroxyl groups on their surfaces, they exhibit good dispersibility in water.

The state of the magnetic powder on the surface of the particles and the dispersibility in water of the particles may be evaluated by the same methods as those mentioned above. Hydroxyl group-containing magnetic polymers prepared according to the invention preferably have magnetic powder dispersibility and dispersibility in water which are the same as those previously described for the hydroxyl group-containing magnetic polymer of the invention.

The hydroxyl group-containing magnetic polymer of the invention and a method for its production are described in detail above. The hydroxyl group-containing magnetic polymer obtained by the invention can be employed suitably in applications such as image forming materials, magnetic fluids, diagnostic agents, drug carriers, viscosity regulators, resin materials for molding, paint additives, crosslinking/hardening agents and cosmetics additives. In the hydroxyl group-containing magnetic polymer, a certain amount or more of magnetic powder is dispersed uniformly and the polymer excels in dispersibility in an aqueous medium due to the presence of hydroxyl groups in its surface. Therefore, it can be used as magnetic ink or image forming material for use in a wet image forming process.

### EXAMPLES

The invention is described in detail below with reference to Examples, but the invention is not limited thereto. The terms “parts” and “%” used in the Examples are “parts by mass” and “% by mass,” respectively, unless otherwise stated.

<Preparation of Surface Treated Magnetic Powder>

(Magnetic Powder 1)

To 150 parts of dry ethanol, 150 parts of magnetic powder (manufactured by Toda Kogyo Corp., trade name: MTS-010, average particle diameter: 0.13 μm) are added, and 2.5 parts of silane coupling agent (manufactured by Chisso Corporation, trade name: phenethyltrimethoxysilane) is further added. Then, the magnetic powder is ultrasonically dispersed. The ethanol is evaporated from the dispersion with a rotary evaporator, so that the magnetic particles are dried. Subsequently, the particles are heat treated at 150° C. for 5 hours. The thus-treated magnetic powder is not wettable with water (in other words, even when mixed with a small amount of water and stirred, it floats on the surface of the water without settling) and has a hydrophobicized surface. The resultant is called magnetic powder 1.

(Magnetic Powder 2)

Similarly, to 150 parts of dry ethanol, 150 parts of magnetic powder (manufactured by Toda Kogyo Corp., trade name: MTS-010) are added, and 2.5 parts of silane coupling agent (manufactured by Chisso Corporation, trade name: n-decyltrimethoxysilane) are further added. Then, the magnetic powder is ultrasonically dispersed. The ethanol is evaporated from the dispersion with a rotary evaporator, so that the magnetic particles are dried. Subsequently, the particles are heat treated at 150° C. for 5 hours. The thus-treated magnetic powder is not wettable with water and has a hydrophobicized surface. The resultant is called magnetic powder 2.

### Example 1

<Preparation of Hydroxyl Group-Containing Magnetic Polymer>

11 parts of hydroxyethyl methacrylate (manufactured by Wako Pure Chemical Industries, Ltd.), 35 parts of styrene monomer (manufactured by Wako Pure Chemical Industries, Ltd.), 1 part of divinylbenzene (manufactured by Wako Pure Chemical Industries, Ltd.) and, as organic solvent, 25 parts of diethylbenzene (manufactured by Wako Pure Chemical Industries, Ltd.) and 25 parts of isoamyl alcohol (manufactured by Wako Pure Chemical Industries, Ltd.) are mixed, and then 42 parts of magnetic powder 1 is added. The mixture is subjected to dispersion with a ball mill for 48 hours. To 90 parts of this magnetic powder dispersion, 5 parts of azobisisobutyronitrile (manufactured by Wako Pure Chemical Industries, Ltd.) as a polymerization initiator are added. Thus, a mixture including a monomer and a magnetic powder is prepared.

To an aqueous solution prepared by dissolving 28 parts of sodium chloride in 160 parts of ion exchange water, 30 parts of calcium carbonate (manufactured by Maruo Calcium Co., Ltd., trade name: LUMINUS) and 3.5 parts of carboxymethylcellulose (manufactured by Dai-Ichi Kogyo Seiyaku Co., Ltd., trade name: CELLOGEN) as dispersion stabilizer are added and then dispersed with a ball mill for 24 hours to form a dispersion medium. To 200 parts of this dispersion medium, the aforementioned mixture is charged and then emulsified for 3 minutes at 8000 rpm with an emulsifying machine (manufactured by SMT Co., Ltd., HIGH-FLEX HOMOGENIZER) to yield a suspension. The suspension particles have a number average particle diameter of about 2.5 μm.

Meanwhile, into a separable flask equipped with a stirrer, a thermometer, a cooling tube and a nitrogen introduction tube, nitrogen is introduced through the nitrogen introduction tube, whereby the flask is filled with a nitrogen atmosphere. The above-mentioned suspension is placed therein and is allowed to react at 65° C. for 3 hours. Further, it is heated at 70° C. for 10 hours and then cooled. The reaction solution turns into a good dispersion, during the polymerization, no aggregates can be observed visually. Addition of a 10% aqueous hydrochloric acid solution to the reaction solution to decompose calcium carbonate is followed by solid-liquid separation by centrifugal separation. Resulting particles are washed with 1-L of ion exchange water, followed by washing with 500-ml of ethanol under ultrasonic irradiation for 30 minutes three times. Thus, polymer particles A are obtained.

The polymer particles A are dried in an oven at 60° C., and then the amount of the magnetic polymer produced is measured to be 54 parts. The yield thereof is 93%.

Based on a weight loss caused by heating by thermogravimetric analysis (TGA), the content of magnetic powder in the particles is calculated to be 46% by mass. The measurement of TGA is carried out under conditions where the temperature is increased to 600° C. at a rate of 10° C./min and kept at 600° C. for 10 minutes.

(Characteristic Evaluation of Hydroxyl Group-Containing Magnetic Polymer)

—Amount of Hydroxyl Groups—

A polymer is weighed and placed in a test tube with a cap. A prescribed amount of a solution, prepared in advance, of acetic anhydride (manufactured by Wako Pure Chemical Industries, Ltd.) in pyridine (manufactured by Wako Pure Chemical Industries, Ltd.) is added and heated at a temperature of 95° C. for 24 hours.

Further, distilled water is added to hydrolyze the acetic anhydride in the test tube. Then, centrifugal separation is carried out at 3000 rpm for 5 minutes to separate the mixture into particles and a supernatant. Further, the polymer is washed with ethanol (manufactured by Wako Pure Chemical Industries, Ltd.) by ultrasonic dispersion and centrifugal separation conducted repeatedly. The supernatants and washings are collected in a conical beaker and titrated with a 0.1M ethanolic potassium hydroxide solution (manufactured by Wako Pure Chemical Industries, Ltd.) using phenolphthalein (manufactured by Wako Pure Chemical Industries, Ltd.) as an indicator.

A blank test using no polymer is also carried out. Based on the difference between both titrations, the amount of hydroxyl groups (mmol/g) is calculated according to the following formula (1).
Amount of hydroxyl groups=((B−C)×0.1×f)/(w−(w×D/100)) (1)

In formula (1), B is the dropped amount (ml) in the blank test, C is the amount (ml) of drops of the sample, f is the factor of the potassium hydroxide solution, w is the weight (g) of the particles, and D is the content (%) of magnetic powder in the particles.

As a result, the amount of hydroxyl groups in polymer particles A is 1.2 mmol/g.

—Number Average Particle Diameter and Form of Particles—

Based on a photograph taken by electron microscope observation of dry particles, the number average particle diameter of the polymer particles is determined to be 2.2 μm. In the photograph, no agglomerated particles are found.

—State of Magnetic Powder on the Surface of Particles—

The state of the magnetic powder on the surface of polymer particles A is checked with a scanning electron microscope (SEM). Specifically, when 100 particles are examined for their surface conditions at a magnification of 10000, a state where the magnetic powder projects on the surface is not found in any particle.

—Dispersibility in Water of Polymer Particles—

One part of dried polymer particles A is added to 20 parts of pure water in a glass container having an opening with an area of 4 cm² and then stirred. The particles are dispersed well again in water while no particles float on the surface of the water or deposite on the wall of the container.

### Example 2

<Preparation of Hydroxyl Group-Containing Magnetic Polymer>

25 parts of hydroxyethyl methacrylate (manufactured by Wako Pure Chemical Industries, Ltd.), 20 parts of styrene monomer (manufactured by Wako Pure Chemical Industries, Ltd.) and 1 part of divinylbenzene (manufactured by Wako Pure Chemical Industries, Ltd.) are mixed. Subsequently, 50 parts of lauryl alcohol (manufactured by Wako Pure Chemical Industries, Ltd.) as organic solvent are mixed therewith and then 42 parts of magnetic powder 2 are added. The mixture is subjected to dispersion with a ball mill for 48 hours. To 90 parts of this magnetic powder dispersion, 5 parts of azobisisobutyronitrile (manufactured by Wako Pure Chemical Industries, Ltd.) as a polymerization initiator are added, whereby a mixture including a monomer and a magnetic powder is prepared.

To an aqueous solution prepared by dissolving 28 parts of sodium chloride in 160 parts of ion exchange water, 30 parts of calcium carbonate (manufactured by Maruo Calcium Co., Ltd., trade name: LUMINUS) and 3.5 parts of carboxymethylcellulose (manufactured by Dai-Ichi Kogyo Seiyaku Co., Ltd., trade name: CELLOGEN) as dispersion stabilizer are added, and then dispersed with a ball mill for 24 hours to form a dispersion medium. To 200 parts of this dispersion medium, the aforementioned mixture is charged and then emulsified for 3 minutes at 8000 rpm with an emulsifying machine (manufactured by SMT Co., Ltd., HIGH-FLEX HOMOGENIZER) to yield a suspension. The suspension particles have a number average particle diameter of about 2.5 μm.

Meanwhile, into a separable flask equipped with a stirrer, a thermometer, a cooling tube and a nitrogen introduction tube, nitrogen is introduced through the nitrogen introduction tube, whereby the flask is filled with a nitrogen atmosphere. The above-mentioned suspension is placed therein and is allowed to react at 65° C. for 3 hours. Further, it is heated at 70° C. for 10 hours and then cooled. The reaction solution turns into a good dispersion, and during the polymerization, no aggregates can be observed visually. Addition of a 10% aqueous hydrochloric acid solution to the reaction solution to decompose calcium carbonate is followed by solid-liquid separation by centrifugal separation. Resulting particles are washed with 1-L of ion exchange water, followed by washing with 500-ml of ethanol under ultrasonic irradiation for 30 minutes three times. Thus, polymer particles B are obtained.

The polymer particles B are dried in an oven at 60° C., and then the amount of the magnetic polymer produced is measured to be 52 parts. The yield thereof is 90%.

Based on a weight loss caused by heating by thermogravimetric analysis (TGA), the content of magnetic powder in the particles is calculated to be 47% by mass.

(Characteristic Evaluation of Hydroxyl Group-Containing Magnetic Polymer)

The amount of hydroxyl groups in polymer particles B is measured by the same method as that of Example 1. The amount of hydroxyl groups in the particles is 1.94 mmol/g.

The number average particle diameter is determined in a manner like that of Example 1 to be 2.0 μm. No aggregated particles are found.

Next, when the state of a magnetic powder on the surface of particles and the dispersibility in water of the particles are also checked in the same manners as those in Example 1, no magnetic powder projecting on the surface of particles is found and the dispersibility in water is good like Example 1.

### Example 3

<Preparation of Hydroxyl Group-Containing Magnetic Polymer>

21 parts of hydroxyethyl methacrylate (manufactured by Wako Pure Chemical Industries, Ltd.), 25 parts of styrene monomer (manufactured by Wako Pure Chemical Industries, Ltd.) and 1 part of divinylbenzene (manufactured by Wako Pure Chemical Industries, Ltd.) are mixed. Subsequently, 25 parts of diethylbenzene (manufactured by Wako Pure Chemical Industries, Ltd.) and 25 parts of lauryl alcohol (manufactured by Wako Pure Chemical Industries, Ltd.) as organic solvent are mixed therewith and then 42 parts of the magnetic powder 1 is added. The mixture is subjected to dispersion with a ball mill for 48 hours. To 90 parts of this magnetic powder dispersion, 5 parts of azobisisobutyronitrile (manufactured by Wako Pure Chemical Industries, Ltd.) as a polymerization initiator is added. Thus, a mixture including a monomer and a magnetic powder is prepared.

To an aqueous solution prepared by dissolving 28 parts of sodium chloride in 160 parts of ion exchange water, 30 parts of calcium carbonate (manufactured by Maruo Calcium Co., Ltd., trade name: LUMINUS) and 1.5 parts of carboxymethylcellulose (manufactured by Dai-Ichi Kogyo Seiyaku Co., Ltd., trade name: CELLOGEN) as dispersion stabilizer are added and then dispersed with a ball mill for 24 hours to form a dispersion medium. To 200 parts of this dispersion medium, the aforementioned mixture is charged and then emulsified for 3 minutes at 6000 rpm with an emulsifying machine (manufactured by SMT Co., Ltd., HIGH-FLEX HOMOGENIZER) to yield a suspension. The suspension particles have a number average particle diameter of about 5.4 μm.

Meanwhile, into a separable flask equipped with a stirrer, a thermometer, a cooling tube and a nitrogen introduction tube, nitrogen is introduced through the nitrogen introduction tube, whereby the flask is filled with a nitrogen atmosphere. The above-mentioned suspension is placed therein and is allowed to react at 65° C. for 3 hours. Further, it is heated at 70° C. for 10 hours and then cooled. The reaction solution turns into a good dispersion, and during the polymerization, no aggregates can be observed visually. Addition of a 10% aqueous hydrochloric acid solution to the reaction solution to decompose calcium carbonate is followed by solid-liquid separation by centrifugal separation. Resulting particles are washed with 1 L of ion exchange water and then dried at 80° C. Subsequently, Soxlet extraction with 500 ml of ethanol is conducted for 6 hours to remove the solvent in the particles by extraction. Then, the particles are subjected three times to washing by stirring in 500 ml of ion exchange water followed by centrifugal separation. Thus, polymer particles C are obtained.

The polymer particles C are freeze dried at 40° C., and then the amount of the magnetic polymer produced is measured to be 52 parts. The yield thereof is 90%.

Based on a weight loss caused by heating by thermogravimetric analysis (TGA), the content of magnetic powder in the particles is calculated to be 46% by mass.

(Characteristic Evaluation of Hydroxyl Group-Containing Magnetic Polymer)

The amount of hydroxyl groups in polymer particles C is measured by the same method as that of Example 1. The amount of hydroxyl groups in the particles is 2.67 mmol/g.

The number average particle diameter is determined in a manner like that of Example 1 to be 4.8 μm. No aggregated particles are found.

Next, when the state of a magnetic powder on the surface of particles and the dispersibility in water of the particles are also checked in the same manners as those in Example 1, no magnetic powder projecting on the surface of particles is found and the dispersibility in water is good like Example 1.

### Example 4

<Preparation of Hydroxyl Group-Containing Magnetic Polymer>

25 parts of polyethyleneglycol methacrylate (manufactured by NOF Corporation, BLEMMER PE350), 20 parts of styrene monomer (manufactured by Wako Pure Chemical Industries, Ltd.) and 1 part of divinylbenzene (manufactured by Wako Pure Chemical Industries, Ltd.) are mixed. Subsequently, 50 parts of lauryl alcohol (manufactured by Wako Pure Chemical Industries, Ltd.) as organic solvent is mixed therewith and then 42 parts of magnetic powder 2 are added. The mixture is subjected to dispersion with a ball mill for 48 hours. To 90 parts of this magnetic powder dispersion, 5 parts of azobisisobutyronitrile (manufactured by Wako Pure Chemical Industries, Ltd.) as a polymerization initiator is added. Thus, a mixture including a monomer and a magnetic powder is prepared.

To an aqueous solution prepared by dissolving 28 parts of sodium chloride in 160 parts of ion exchange water, 30 parts of calcium carbonate (manufactured by Maruo Calcium Co., Ltd., trade name: LUMINUS) and 3.5 parts of carboxymethylcellulose (manufactured by Dai-Ichi Kogyo Seiyaku Co., Ltd., trade name: CELLOGEN) as dispersion stabilizer are added and then dispersed with a ball mill for 24 hours to form a dispersion medium. To 200 parts of this dispersion medium, the aforementioned mixture is charged and then emulsified for 3 minutes at 8000 rpm with an emulsifying machine (manufactured by SMT Co., Ltd., HIGH-FLEX HOMOGENIZER) to yield a suspension. The suspension particles have a number average particle diameter of about 2.8 μm.

Meanwhile, into a separable flask equipped with a stirrer, a thermometer, a cooling tube and a nitrogen introduction tube, nitrogen is introduced through the nitrogen introduction tube, whereby the flask is filled with a nitrogen atmosphere. The above-mentioned suspension is placed here and is allowed to react at 65° C. for 3 hours. Further, it is heated at 70° C. for 10 hours and then cooled. The reaction solution turns into a good dispersion, and during the polymerization, no aggregates can be observed visually. Addition of a 10% aqueous hydrochloric acid solution to the reaction solution to decompose calcium carbonate is followed by solid-liquid separation by centrifugal separation. Resulting particles are washed with 1 L of ion exchange water and then dried at 80° C. Subsequently, Soxlet extraction with 500 ml of ethanol is conducted for 6 hours to remove the solvent in the particles by extraction. Then, the particles are subjected three times to washing by stirring in 500 ml of ion exchange water followed by centrifugal separation. Thus, polymer particles D are obtained. The polymer particles D are freeze dried at 40° C., and then the amount of the magnetic polymer produced is measured to be 49 parts. The yield thereof is 86%.

Based on a weight loss caused by heating by thermogravimetric analysis (TGA), the content of magnetic powder in the particles is calculated to be 46% by mass.

(Characteristic Evaluation of Hydroxyl Group-Containing Magnetic Polymer)

The amount of hydroxyl groups in polymer particles D is measured by the same method as that of Example 1. The amount of hydroxyl groups in the particles is 1.2 mmol/g.

The number average particle diameter is determined in a manner like that of Example 1 to be 4.8 μm. No aggregated particles are found.

Next, when the state of a magnetic powder on the surface of particles and the dispersibility in water of the particles are also checked in the same manners as those in Example 1, no magnetic powder projecting on the surface of particles is found and the dispersibility in water is good like Example 1.

### Example 5

<Preparation of Hydroxyl Group-Containing Magnetic Polymer>

Polymer particles E are obtained by conducting suspension polymerization in the same formulation as Example 1 except for using, as a magnetic powder in Example 2, a magnetic powder the surface of which has not been treated with a silane coupling agent (manufactured by Toda Kogyo Corp., trade name: MTS-010). The amount of the resulting magnetic polymer is weighed to be 34 parts and the yield is 59%. Based on a weight loss caused by heating by thermogravimetric analysis (TGA), the content of magnetic powder in the particles is calculated to be 25% by mass.

(Characteristic Evaluation of Hydroxyl Group-Containing Magnetic Polymer)

The amount of hydroxyl groups in polymer particles E is measured by the same method as that of Example 1. The amount of hydroxyl groups in the particles is 1.13 mmol/g.

The number average particle diameter is determined in a manner like that of Example 1 to be 2.5 μm. No aggregated particles are found.

An SEM observation of the resulting polymer particles E shows that there are some particles in which a magnetic powder projects on the surface. However, when the dispersibility in water of the particles is checked like in Example 1, no particles float on the surface of water or attach to the surface of a container and, therefore, the dispersibility in water is good.

### Comparative Example 1

Polymer particles F are obtained by conducting suspension polymerization in the same formulation as Example 1 except for using, as the organic solvents, no diethylbenzene and lauryl alcohol, in Example 3. In this case, aggregates are found during the polymerization. The amount of the resulting magnetic polymer is weighed to be 28 parts and the yield decreases to 48%.

The amount of hydroxyl groups in the resulting polymer particles F is measured by the same method as that of Example 1. The amount of hydroxyl groups in the particles is as small as 0.06 mmol/g. A microscopic observation of these polymer particles shows that the number average particle diameter is 2.2 μm though there is a wide range of particle size variation. A considerable number of agglomerated particles is found.

An SEM observation of the resulting polymer particles F shows that there are some particles in which a magnetic powder projects on the surface. However, when the dispersibility in water of the particles is checked like in Example 1, the particles form aggregates (masses composed of agglomerated particles) and therefore do not re-disperse well in water. The resulting polymer particles F are hydrophobic.

### Comparative Example 2

When a mixture including monomers and a magnetic powder is suspended and polymerized through treatments like those in Example 1 except for adding no sodium chloride during the preparation of a dispersion medium in Example 1, white fine particles which pass through a filter paper (No. 5C, manufactured by ADVANTEC; retentive particle diameter=1 μm) are found in rinsing with ion exchange water. This shows that emulsion polymerization occurs also in the dispersion medium. The amount of the resulting polymer particles G is weighed to be 23 parts and the yield decreases to 40%.

The amount of hydroxyl groups in the resulting polymer particles G is measured by the same method as that of Example 1. The amount of hydroxyl groups in the particles is as small as 0.03 mmol/g. A microscopic observation of these polymer particles shows that the number average particle diameter is 2.0 μm though there is a wide range of particle size variation. A considerable number of agglomerated particles is found.

An SEM observation of the resulting polymer particles G shows that in some portions a magnetic powder projects on the surface of particles. However, when the dispersibility in water of the particles is checked like in Example 1, the particles form aggregates (masses composed of agglomerated particles) and therefore do not re-disperse well in water. The resulting polymer particles G are hydrophobic.

### Comparative Example 3

An attempt to suspend a mixture including monomers and a magnetic powder and polymerize it through treatments like those in Example 1 except for adding no calcium carbonate during the preparation of a dispersion medium in Example 1 fails to suspend the mixture well in the dispersion medium. Even if polymerization is conducted, a cluster-like mass is formed.

As described above, according to the method for producing a hydroxyl group-containing magnetic polymer of the invention, suspension particles are stable during polymerization and, therefore, the particles do not generate agglomeration and polymer particles in which a magnetic powder is uniformly dispersed in a high concentration are formed. On the other hand, in Comparative Examples, which lack at least one of the aforementioned production conditions in the invention, there arises some problem in yield, state of particles, etc.

All publications, patent applications, and technical standards mentioned in this specification are herein incorporated by reference to the same extent as if each individual publication, patent application, or technical standard was specifically and individually indicated to be incorporated by reference.

What is claimed is:

1. A hydroxyl group-containing magnetic polymer that is a particulate hydroxyl group-containing magnetic polymer comprising a magnetic powder and a polymer of ethylenically unsaturated monomers, the content of the magnetic powder being within the range of from approximately 5 to approximately 90% by mass, the ethylenically unsaturated monomers comprising a hydrophilic monomer having a hydroxyl group and a hydrophobic monomer, and the amount of hydroxyl groups in the portion of the hydroxyl group-containing polymer excluding the magnetic powder being within the range of from approximately 0.3 to approximately 5.0 mmol/g.

2. The hydroxyl group-containing magnetic polymer according to claim 1, wherein the number average particle diameter of the hydroxyl group-containing magnetic polymer is within the range of from about 0.5 to about 5 μm.

3. The hydroxyl group-containing magnetic polymer according to claim 1, wherein the content of hydrophobic monomers is within the range of from about 20.0 to about 99.9% by mass of the total monomer components.

4. The hydroxyl group-containing magnetic polymer according to claim 1, wherein the content of hydrophobic monomers is within the range of from about 50.0 to about 90.0% by mass of the total monomer components.

5. The hydroxyl group-containing magnetic polymer according to claim 1, wherein hydrophilic monomers having the hydroxyl group comprises at least one selected from 2-hydroxyethyl(meth)acrylate and polyethylene glycol(meth)acrylate.

6. The hydroxyl group-containing magnetic polymer according to claim 1, wherein the ethylenically unsaturated monomers comprise a crosslinking agent.

7. A method for producing a hydroxyl group-containing magnetic polymer comprising; dispersing a mixture that comprises ethylenically unsaturated monomers comprising a hydrophilic monomer having a hydroxyl group and a hydrophobic monomer, an organic solvent, a polymerization initiator and a magnetic powder, the surface of which has been subjected to hydrophobicizing treatment, in an aqueous medium in which a salt has been dissolved and to which a dispersion stabilizer has been added, followed by conducting suspension polymerization.

8. The method for producing a hydroxyl group-containing magnetic polymer according to claim 7, wherein the number average particle diameter is within the range of from approximately 0.5 to approximately 5 μm.

9. The method for producing a hydroxyl group-containing magnetic polymer according to claim 7, wherein the content of hydrophobic monomers is within the range of from approximately 20.0 to approximately 99.9% by mass of the total monomer component.

10. The method for producing a hydroxyl group-containing magnetic polymer according to claim 7, wherein the content of hydrophobic monomers is within the range of from approximately 50.0 to approximately 90.0% by mass of the total monomer component.

11. The method for producing a hydroxyl group-containing magnetic polymer according to claim 7, wherein the hydrophilic monomers having the hydroxyl group comprises at least one selected from 2-hydroxyethyl(meth)acrylate and polyethylene glycol (meth)acrylate.

12. The method for producing a hydroxyl group-containing magnetic polymer according to claim 7, wherein the organic solvent is at least one selected from diethylbenzene, lauryl alcohol and isoamyl alcohol.

13. The method for producing a hydroxyl group-containing magnetic polymer according to claim 7, wherein the hydrophobicizing treatment is surface coating with a coupling agent.

14. The method for producing a hydroxyl group-containing magnetic polymer according to claim 7, wherein the salt is an inorganic salt.

15. The method for producing a hydroxyl group-containing magnetic polymer according to claim 7, wherein the dispersion stabilizer is an inorganic powder.

16. The method for producing a hydroxyl group-containing magnetic polymer according to claim 7, wherein the ethylenically unsaturated monomers comprise a crosslinking agent.

17. The method for producing a hydroxyl group-containing magnetic polymer according to claim 7, wherein the concentration of the salt in the aqueous medium is approximately 5% by mass or more.

18. The method for producing a hydroxyl group-containing magnetic polymer according to claim 7, wherein the aqueous medium is water.

19. The method for producing a hydroxyl group-containing magnetic polymer according to claim 7, wherein the content of the dispersion stabilizer is within the range of from approximately 1 to approximately 100 parts by mass based on approximately 100 parts by mass of a mixture comprising the monomers and the magnetic powder.
